(19) United States
(12) Patent Application Publication
(10) Pub. No.: US 2018/0226056 A1
(43) Pub. Date: Aug. 9, 2018

(54) DISPLAY APPARATUS

(71) Applicant: Charn-Hang Cliff CHAN, Hong Kong (CN)

(72) Inventor: Charn-Hang Cliff CHAN, Hong Kong (CN)

(21) Appl. No.: 15/741,547

(22) PCT Filed: Jul. 1, 2016
(86) PCT No.: PCT/CN2016/088229

§ 371 Date: Jan. 3, 2018

(30) Foreign Application Priority Data
Jul. 3, 2015 (HK) 15106361.1

(51) Int. Cl. G09G 5/10; G06F 3/14

(52) U.S. Cl. CPC G09G 5/10; G06F 3/1446

(57) ABSTRACT

A display apparatus (1) comprises a plurality of display units (2), each display unit (2) has an adjustable opacity panel (3) switchable between a transparent state and a high opacity state, and a display space (4) for holding an item behind the panel (3), the display space (4) being visible through the panel (3) in the transparent state and not visible in the high opacity state. A controller (5) is configured to switch the panels (3) between the transparent and high opacity states in accordance with one or more of the following: a preset program, a remote instruction from a user, a touch input from a user.

### TECHNICAL FIELD

The invention relates to display apparatuses, and in particular, display apparatuses for displaying items behind transparent panels.

### BACKGROUND ART

Display cases, cabinets, or units are useful for displaying products for sale or for displaying objects for viewing. Display cases and the like are passive devices, simply providing a location to place an object for display. Other than viewing the object, the viewer typically has no interaction with the display case. When it is no longer desirable to display an object, the object either need to be removed, or the display case needs to be covered.

Information about the product or object in the display case is usually provided on signs or boards within or adjacent the display case, or alternatively, located elsewhere. This requires someone to manually provide such information, and when there is a requirement to change this information, someone also needs to intervene to do so. Also, the amount of information provided is typically limited to the size of the sign or board provided. Furthermore, the information is passive whereby a viewer only interacts with the information by simply viewing the information.

It is an object of the present invention to overcome or ameliorate at least one of the disadvantages of the prior art, or to provide a useful alternative.

### DISCLOSURE OF INVENTION

### Solution to Problem

### Technical Solution

The present invention provides, in one aspect, a display apparatus comprising:

a plurality of display units, each having an adjustable opacity panel switchable between a transparent state and a high opacity state, and a display space for holding an item behind the panel, the display space being visible through the panel in the transparent state and not visible in the high opacity state; and

a controller configured to switch the panels between the transparent and high opacity states in accordance with one or more of the following: a preset program, a remote instruction from a user, a touch input from a user.

In one embodiment, the display apparatus comprises one or more light sources, each light source having a colour such that when one of the light sources is on, at least one panel adopts the colour of said one light source, or when a plurality of the light sources is on, said panel adopts the combination of colours of said light sources.

In one embodiment, the controller is configured to switch the light sources on or off in accordance with one or more of the following: a preset program, a remote instruction from a user, a touch input from a user.

In one embodiment, one or more display units comprises a projector for projecting visual content onto the panel of said display unit, the visual content being visible on said panel in the high opacity state.

In one embodiment, the controller is configured to perform one or more of the following:

projecting visual content onto said panel,

changing the visual content projected onto said panel,

in accordance with one or more of the following:

a preset program,

a remote instruction from a user,

a touch input from a user.

In one embodiment, the preset program is embedded within the controller, or is located locally or remotely in one of the following: a desktop computer, a laptop computer, a tablet computer, a handheld device, a smartphone.

In one embodiment, the remote instruction is issued via one or a combination of the following: a desktop computer, a laptop computer, a tablet computer, a handheld device, a smartphone.

In one embodiment, one or more of the following characteristics of the high opacity state is variable: colour, tint, shade, tone, degree of opacity.

In one embodiment, at least one panel has a semi-transparent state between the transparent and high opacity states, an item in the display space behind said panel being partially visible in the semi-transparent state, the controller configured to switch said panel between the transparent, semi-transparent, and high opacity states in accordance with one or more of the following: a preset program, a remote instruction from a user, a touch input from a user.

In one embodiment, the display units are modular and each display unit is positionable into a different position relative to the other display units.

In one embodiment, one or more display units are connectable to the controller via another display unit.

In one embodiment, one or more display units are connectable to the controller via another display unit by means of a contact connection between the display units.

In one embodiment, the panel is coloured.

Throughout this specification, including the claims, the words “comprise”, “comprising”, and other like terms are to be construed in an inclusive sense, that is, in the sense of “including, but not limited to”, and not in an exclusive or exhaustive sense, unless explicitly stated otherwise or the context clearly requires otherwise.

### BRIEF DESCRIPTION OF DRAWINGS

### Description of Drawings

Preferred embodiments in accordance with the best mode of the present invention will now be described, by way of example only, with reference to the accompanying figures, in which the same reference numerals refer to like parts throughout the figures unless otherwise specified, and in which:

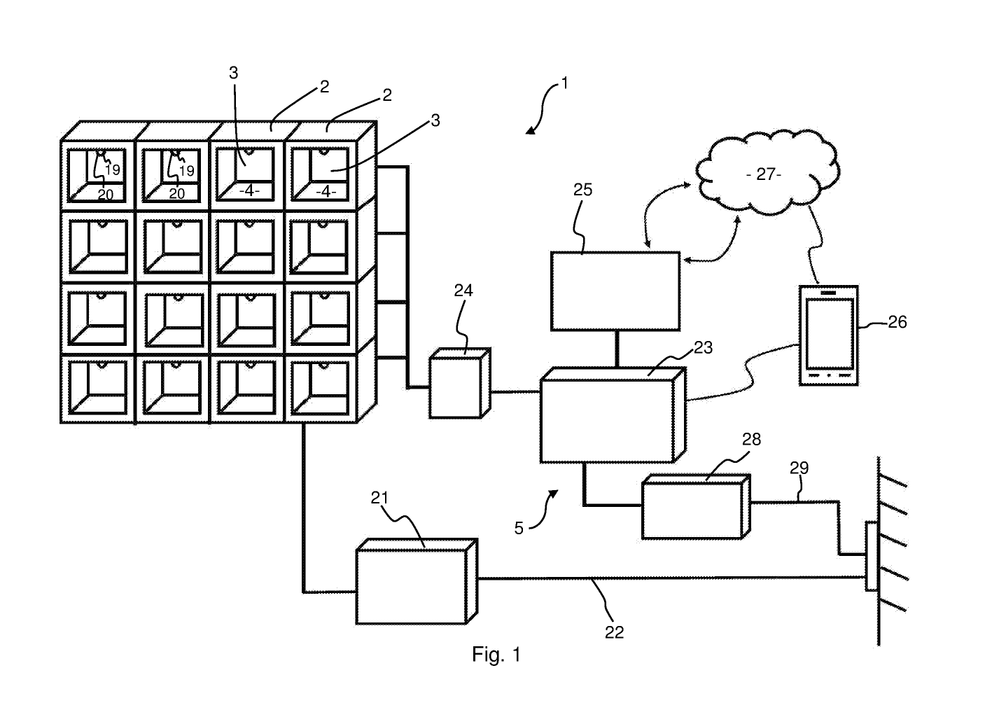

FIG. 1 is a schematic diagram of a display apparatus in accordance with an embodiment of the present invention; and

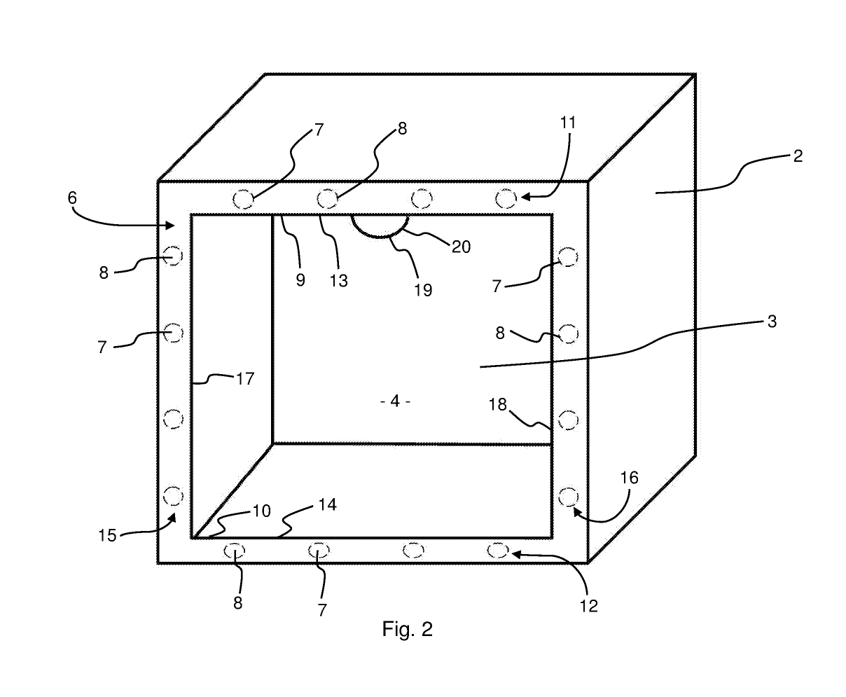

FIG. 2 is a schematic diagram of a display unit of the display apparatus of FIG. 1.

### MODE FOR THE INVENTION

### Mode for Invention

Referring to the figures, there is provided a display apparatus 1 comprising a plurality of display units 2. Each display unit 2 has an adjustable opacity panel 3 switchable between a transparent state and a high opacity state, and a display space 4 for holding an item behind the panel 3, the display space 4 being visible through the panel in the transparent state and not visible in the high opacity state. A controller 5 is configured to switch the panels between the transparent and high opacity states in accordance with one or more of the following: a preset program, a remote instruction from a user, a touch input from a user.

For example, the preset program can switch the panels between the transparent and high opacity states in accordance with a predetermined time schedule. One or more of the panels can be in the transparent state during a predetermined portion of a day and in the high opacity state during another portion of the day. The preset program can switch the panels between the transparent and high opacity states in accordance with a predetermined pattern. In one embodiment, all of the panels are in the high opacity state except for one which is in the transparent state. After a predetermined period of time, the panel in the transparent state switches to the high opacity state, whilst another panel switches to the transparent state. This process repeats randomly or cycles through each panel.

In order to detect a touch input, the display apparatus 1 has a touch sensor 6 comprising an emitter 7 and a receiver 8. The emitter 7 emits non-visible radiation across at least one panel 3 for receipt by the receiver 8, with the touch input being detected when an input object is placed on or adjacent the panel thereby interfering with the non-visible radiation. The input object can be, for example, a user's finger or hand.

The emitter 7 is located at or near a first periphery 9 of the panel 3, and the receiver 8 is located at or near a second periphery 10 of the panel opposing the first periphery 9.

In one embodiment, the touch sensor 6 comprises a plurality of said emitters 7 and a plurality of said receivers 8 arranged in a first linear array 11 and a second linear array 12. The first linear array 11 comprises emitters 7 or a combination of emitters 7 and receivers 8, and the second linear array 12 comprises receivers 8 or a combination of emitters 7 and receivers 8, with each emitter 7 emitting non-visible radiation across the panel 3 for receipt by one or more of the receivers 8.

Typically, but not exclusively, the panel 3 is rectangular and the first linear array 11 is located along or adjacent a first edge 13 of the panel, and the second linear array 12 is located along or adjacent a second edge 14 of the panel opposite the first edge.

In some embodiments, the touch sensor 6 comprises a third linear array 15 comprising emitters 7 or a combination of emitters 7 and receivers 8, and a fourth linear array 16 comprising receivers 8 or a combination of emitters 7 and receivers 8. The third linear array 15 is located along or adjacent a third edge 17 of the panel 3, and the fourth linear array 16 is located along or adjacent a fourth edge 18 of the panel opposite the third edge.

The non-visible radiation can be infrared radiation or any other suitable type of non-visible radiation.

The controller 5 can be configured such that when a touch input is detected on or adjacent a panel 3, or on or adjacent a predefined portion of the panel 3, the controller switches the panel between the transparent and the high opacity states.

In one embodiment, the sensor 6 only detects touch inputs in one or more active areas of the panel 3, with the remaining area of the display being inactive in terms of detecting touch inputs. This can be done by controlling the sensor 6 so that only the emitters 7 and receivers 8 covering the one or more active areas are operating. The remaining emitters 7 and receivers 8 can be placed into an inoperative condition or touch inputs detected by the remaining emitters 7 and receivers 8 can be ignored. Alternatively, the display apparatus 1 can be provided with a sensor 6 that only covers the one or more active areas. For example, there can be just one active area in the top left hand corner of the panel 3. The first and second linear arrays 11 and 12, and the third and fourth linear arrays 15 and 16 if they exist, are only of a length that allows the active area to be covered. This is useful in applications where it is desirable to restrict the user input from users to one or more specific active areas. The remaining area can remain in the transparent state, or can remain in the high opacity state.

The display apparatus 1 comprises one or more light sources 19. Each light source 19 has a colour such that when one of the light sources 19 is on, at least one panel 3 adopts the colour of said one light source, or when a plurality of the light sources 19 is on, said panel 3 adopts the combination of colours of said light sources. The light sources 19 can be located behind the panel 3. For example, the light sources 19 can be one or more LED lights which can be mounted on a wall of the display space 4. Alternatively, the light sources can be located external to the display unit 2. For example, the light sources can be one or more LED lights mounted from a ceiling area in front of the display units 2. These light sources can be selectively projectable to one or more panels 3.

The controller 5 is configured to switch the light sources 19 on or off in accordance with one or more of the following: a preset program, a remote instruction from a user, a touch input from a user.

For example, the preset program can switch on one or more of the light sources 19 whenever the panel 3 switches to the transparent state and switch off one or more of the light sources 19 whenever the panel 3 switches to the high opacity state, or vice versa. In another example, the preset program switches the light sources 19 on or off so that different panels 3 adopt the colour or colours of the light sources in a pattern. This pattern can be random or predetermined, and can repeat in cycles.

The controller 5 can also switch one or more of the light sources 19 on or off in accordance with a touch input from a user whereby the touch input is detected by a touch sensor such as the touch sensor 6 described above. The controller 5 can be configured such that when a touch input is detected on or adjacent a panel 3, or on or adjacent a predefined portion of the panel 3, the controller switches the one or more of the light sources 19 on or off.

In one simple embodiment, the light sources 19 are switched on and off using one or more manual switches. There can be one manual switch for each light source 19 or one manual switch can switch a group of the light sources 19 on or off together.

In some embodiments, one or more display units 2 comprises a projector 20 for projecting visual content onto the panel 3 of said display unit, the visual content being visible on said panel in the high opacity state. The controller 5 is configured to perform one or more of the following: projecting visual content onto said panel, or changing the visual content projected onto said panel. The controller 5 performs these actions in accordance with one or more of the following: a preset program, a remote instruction from a user, or a touch input from a user.

For example, a preset program can start to project visual content onto one or more of the panels 3 at a predetermined time. The present program can change the visual content projected onto the panel 3 at predetermined times. The preset program can start to project visual content onto one or a subset of the panels 3 at a predetermined time, and then move the visual content onto another panel 3 or another subset of the panels 3 after a predetermined time period. The said another or another subset of panels will of course need to be switched to the high opacity state, if not already in this state, before the visual content is moved. The panel 3 or subset of panels on which the visual content was previously projected can either remain in the high opacity state or can be switched to the transparent state once the visual content has moved.

This allows, for example, the plurality of panels 3 to act together as a single large display. Each panel 3 can be regarded as a “pixel” in the single large display. In one example, all of the panels 3 remain in the high opacity state. Visual content projected onto one panel 3 or a subset of panels 3 can move smoothly across to an adjacent panel 3 or an adjacent subset of panels 3. In another example, only the panel 3 or the subset of panels 3 on which the visual content is projected will be in the high opacity state. The remaining panels will be in the transparent state. Once the visual content moves to one or more adjacent panels 3, which have now switched to the high opacity state, the one or more panels on which the visual content was previously projected will now switch to the transparent state. In other words, the panels in the high opacity state moves with the visual content. This example is useful when there is a desire to keep as many display spaces 4 visible as possible whilst the visual content moves across the panels 3.

Instead of being controlled by a preset program, the visual content can move in accordance with a remote instruction from a user, or a touch input from a user. The visual content can also change depending on the remote instruction from a user, or the touch input from a user. The touch input can be detected by a touch sensor such as the touch sensor 6 described above.

For example, the visual content can be an object. The user can move the object across the panels 3 with touch inputs such as placing a finger adjacent one panel 3 and then swiping the finger across other panels 3. The object then follows the finger movements. In another example, the user interacts with the visual content with touch inputs with the visual content changing in response to the touch inputs. In one particular example, the visual content can be a jigsaw puzzle to be solved by a user. The user solves the puzzle by using touch inputs to move the jigsaw pieces together into the correct arrangement thereby solving the puzzle. Once the puzzle has been solved, the controller 5 switches the panel 3 into the transparent state thereby revealing the display space 4 and any object located in the display space.

The touch input being detected can be a single touch input or a multi-touch input. The touch sensor can detect gesture-type touch inputs. For example, placing two fingers on or adjacent the display 3 and then moving them together (i.e. pinching) can correspond to shrinking the visual content or part of the visual content, whilst moving the fingers apart can correspond to magnifying the visual content or part of the visual content.

Instead of a touch input, a motion input defined by one or more movements of the user can be detected and used to control the visual content. The motion sensor can be a camera with associated software to recognize movements of the user. The camera can be a thermal camera, an infrared camera, or even a camera operating on the normal visual spectrum.

The preset programs described above can be embedded within the controller 5, or can be located locally or remotely in one of the following: a desktop computer, a laptop computer, a tablet computer, a handheld device, a smartphone.

As described above, remote instructions can be issued by a user to, for example, switch the panels 3 between the transparent and high opacity states, switch one or more of the light sources 19 on or off, project visual content or change the visual content on a panel 3. Such remote instructions can be issued via one or a combination of the following: a desktop computer, a laptop computer, a tablet computer, a handheld device, a smartphone.

One or more of the following characteristics of the high opacity state is variable: colour, tint, shade, tone, degree of opacity. For example, the controller 5 can adjust the characteristics in accordance with a preset program or user input. The controller 5 can also adjust the characteristics in coordination with changes in the visual content in embodiments having a projector 20 for projecting visual content onto the panel 3. In one example, how the degree of opacity is varied can depend on the ambient light conditions. In outdoor daylight or other bright ambient conditions, the degree of opacity in the high opacity state can be much higher than in indoor or darker conditions. The visual content projected onto the panel 3 in the high opacity state will require a higher degree of opacity in brighter ambient conditions to be visible since the panel will need to prevent more light coming from the other side of the panel in such conditions. The degree of opacity can also be varied to provide one or more intermediate opacity states in which both the visual content is at least partially visible and the display space 4 behind the panel 3 is partially visible. Furthermore, the degree of opacity can be varied gradually to gradually reveal or gradually hide the display space 4 behind the panel 3, or conversely, gradually hide or gradually reveal the visual content projected onto the panel 3. It is appreciated that the degree of opacity can be varied manually or automatically.

In one particular embodiment, at least one panel 3 has a semi-transparent state between the transparent and high opacity states, an item in the display space 4 behind said panel 3 being partially visible in the semi-transparent state. The controller 5 is configured to switch said panel 3 between the transparent, semi-transparent, and high opacity states in accordance with one or more of the following: a preset program, a remote instruction from a user, a touch input from a user. Examples of how the controller 5 switches between the states in accordance with a preset program, a remote instruction from a user, or a touch input from a user are similar to those given above for switching between the transparent and high opacity states. In one embodiment, there are 14 semi-transparent states between the transparent and high opacity states, giving 16 states in total. However, it is appreciated that other embodiments can have any number of semi-transparent states depending on the application.

The adjustable opacity panel 3 can be switchable glass or switchable laminate on a transparent substrate. The transparent substrate can be of any transparent material suitable for the intended application, and includes glass, Perspex, other transparent polymer materials, transparent ceramics, and transparent crystalline materials. In one embodiment, the panel 3 itself is coloured. For example, the panel can be a laminated structure with a layer of coloured film.

The display units 2 are modular and each display unit is positionable into a different position relative to the other display units. The display units 2 can therefore form a regular rectangular array, or a freeform shape. For example, the display units can be positioned to spell out words or to resemble objects like animals. The display units 2 can be regarded as “pixels” to be arranged to form any shape.

One or more display units 2 are connectable to the controller 5 via another display unit 2. In other words, each display unit 2 can be connected directly to the controller 5 or indirectly through another display unit 2. Where one or more display units 2 are connectable to the controller 5 via another display unit 2, the means of connection can be a contact connection between the display units. For example, each display unit 2 can have a conductive portion, such as a plate, patch, or strip. When one display unit 2 is placed adjacent another display unit 2, the conductive portions of each display unit are in contact with one another. The display units can also include alignment means to ensure that the conductive portions come into contact with one another. Regardless of whether the display units have conductive portions, the alignment means are useful to ensure the display units are regularly aligned when placed adjacent one another. The alignment means can be complementary formations such as ridges and channels. The alignment means can also be magnets.

Instead of conductive portions, the display units 2 can be interconnected through wired connections. This can be in the form of a wire with a plug or socket on both ends which plugs into complementary plugs or sockets on the display units 2. In another embodiment, the wire is simply soldered to solder connections on the display units 2.

In the embodiment shown in FIG. 1, the display apparatus 1 includes a lighting power supply 21 connected to mains power via power cable 22. The lighting power supply 21 provides power to the light sources 19. The controller 5 includes a multiplexer 23 which is connected to a channel switching device 24, which is in turn connected to the display units 2. The controller 5 controls the switchable panels 3, including switching the panels between the transparent and high opacity states, and controls the light sources 19, including switching the light sources on and off, via the multiplexer 23 and the channel switching device 24. The multiplexer 23 can be connected to a web server 25. A user device such as a smartphone 26 can send control instructions to the multiplexer 23 through the internet 27 or other communications network. Another power supply 28 provides power to the multiplexer 23. The power supply is connected to mains power via power cable 29.

In one embodiment, the panel 3 can be fixed to the display unit 2. In another embodiment, the panel 3 can be in the form of a door, or can form part of a door, on the display unit 2. The door can include a lock which can be of any type suitable for a desired application. For example, the lock can be of a type that can be opened by a key, a magnetic swipe card, near field communication, or other wireless control means. In one embodiment, the locking and unlocking of the lock can be controlled by the controller 5, and in one particular example, in coordination with other actions controlled or detected by the controller 5 such as touch inputs or other user inputs, switching the panels 3 between the transparent and high opacity states, switching one or more of the light sources 19 on or off, projecting visual content or changing the visual content on a panel 3.

It is appreciated that the aforesaid embodiments are only exemplary embodiments adopted to describe the principles of the present invention, and the present invention is not merely limited thereto. Various variants and modifications can be made by those of ordinary skill in the art without departing from the spirit and essence of the present invention, and these variants and modifications are also covered within the scope of the present invention. Accordingly, although the invention has been described with reference to specific examples, it is appreciated by those skilled in the art that the invention can be embodied in many other forms. It is also appreciated by those skilled in the art that the features of the various examples described can be combined in other combinations.

1. A display apparatus comprising:
a plurality of display units, each having an adjustable opacity panel switchable between a transparent state and a high opacity state, and a display space for holding an item behind the panel, the display space being visible through the panel in the transparent state and not visible in the high opacity state; and
a controller configured to switch the panels between the transparent and high opacity states in accordance with one or more of the following: a preset program, a remote instruction from a user, a touch input from a user.

2. A display apparatus according to claim 1 comprising one or more light sources, each light source having a colour such that when one of the light sources is on, at least one panel adopts the colour of said one light source, or when a plurality of the light sources is on, said panel adopts the combination of colours of said light sources.

3. A display apparatus according to claim 2 wherein the controller is configured to switch the light sources on or off in accordance with one or more of the following: a preset program, a remote instruction from a user, a touch input from a user.

4. A display apparatus according to claim 1 wherein one or more display units comprises a projector for projecting visual content onto the panel of said display unit, the visual content being visible on said panel in the high opacity state.

5. A display apparatus according to claim 4 wherein the controller is configured to perform one or more of the following:
projecting visual content onto said panel,
changing the visual content projected onto said panel, in accordance with one or more of the following:
a preset program,
a remote instruction from a user,
a touch input from a user.

6. A display apparatus according to claim 1 wherein the preset program is embedded within the controller, or is located locally or remotely in one of the following: a desktop computer, a laptop computer, a tablet computer, a handheld device, a smartphone.

7. A display apparatus according to claim 1 wherein the remote instruction is issued via one or a combination of the following: a desktop computer, a laptop computer, a tablet computer, a handheld device, a smartphone.

8. A display apparatus according to claim 1 wherein one or more of the following characteristics of the high opacity state is variable: colour, tint, shade, tone, degree of opacity.

9. A display apparatus according to claim 1 wherein at least one panel has a semi-transparent state between the transparent and high opacity states, an item in the display space behind said panel being partially visible in the semi-transparent state, the controller configured to switch said panel between the transparent, semi-transparent, and high opacity states in accordance with one or more of the following: a preset program, a remote instruction from a user, a touch input from a user.

10. A display apparatus according to claim 1 wherein the display units are modular and each display unit is positionable into a different position relative to the other display units.

11. A display apparatus according to claim 1 wherein one or more display units are connectable to the controller via another display unit.

12. A display apparatus according to claim 11 wherein one or more display units is connectable to the controller via another display unit by means of a contact connection between the display units.

13. A display apparatus according to claim 1 wherein the panel is coloured.
